(19) United States
(12) Patent Application Publication
(10) Pub. No.: US 2010/0307118 A1
(43) Pub. Date: Dec. 9, 2010

(54) AIR FILTER

(75) Inventors: Eizo Kawano, Osaka (JP); Masatoshi Suzuki, Osaka (JP); Youzou Yano, Osaka (JP); Akio SuzukiI, Osaka (JP)

Correspondence Address: HAMRE, SCHUMANN, MUELLER & LARSON, P.C., P.O. BOX 2902, MINNEAPOLIS, MN, 55402-0902, US

(73) Assignee: NITTO DENKO CORPORATION, Ibaraki-shi, Osaka (JP)

(21) Appl. No.: 12/746,459

(22) PCT Filed: Dec. 4, 2008
(86) PCT No.: PCT/JP2008/072062

§ 371 Date: Aug. 24, 2010

(30) Foreign Application Priority Data
Dec. 6, 2007 (JP) 2007-316400

(51) Int. Cl. B01D 46/40; B01D 46/52

(52) U.S. Cl. 55/483

(57) ABSTRACT

An air filter 100 includes a plurality of filter units 2 and an outer frame 10 surrounding the plurality of filter units 2. The filter units 2 each include a pleated filter medium 4 and a supporting frame 6 holding a peripheral portion 4e of the filter medium 4. Adjacent two filter units 2 and 2 form a V-shape. The plurality of filter units 2 are coupled to each other at the respective supporting frames 6 thereof. The plurality of filter units 2 are fitted in the outer frame 10 so that all of the filter units 2 are inclined with respect to in-plane directions of opening surfaces of the outer frame 10.

### TECHNICAL FIELD

The present invention relates to an air filter.

### BACKGROUND ART

Air filters are used widely for clean rooms, air conditioners, turbines, etc. As this kind of air filter, an air filter obtained by fixing a pleated filter medium to an outer frame is known. As the filter medium, a filter medium such as a glass filter medium, an electret filter medium, and a filter medium including a porous polytetrafluoroethylene (PTFE) membrane is used. It is necessary to use a filter medium having a low pressure loss and a large area when air permeates therethrough at a face velocity of 2.5 m/sec or more. As air filters that can meet this requirement, air filters such as those described in JP 2002-95922 A and JP 2006-88048 A are known. These air filters are often referred to as a V-bank air filter.

The V-bank air filter is produced by the following process. First, a filter medium is pleated. Subsequently, beads are formed on a surface of the filter medium in order to keep the pleat pitch constant. The bead is a yarn-shape structure formed on the surface of the filter medium. Usually, the bead is composed of hot melt resin. Further, the pleated filter medium is formed into a V-shape. Finally, the filter medium is fixed to an outer frame. The outer frame has dimensions as large as 610 mm in length and 610 mm in width when it is a standard type outer frame widely used today. An advanced technique and high cost are required to pleat the filter medium so as to be fitted exactly in the outer frame of such dimensions. It is not preferable for the accuracy in the pleating to be low and a gap generated between the filter medium and the outer frame because this lowers the collecting efficiency of the filter.

### DISCLOSURE OF INVENTION

The present invention is intended to provide an easily produced air filter having an excellent collecting performance.

More specifically, the present invention provides an air filter including: a plurality of filter units; and an outer frame surrounding the plurality of filter units. The plurality of filter units each include a pleated filter medium and a supporting frame holding a peripheral portion of the filter medium. The plurality of filter units are coupled to each other at the respective supporting frames thereof so that adjacent two of the filter units form a V-shape. The plurality of filter units are fitted in the outer frame so that all of the filter units are inclined with respect to opening surfaces of the outer frame.

In the present invention, the plurality of filter units are coupled to each other at the respective supporting frames thereof and fitted in the outer frame. This makes it possible to avoid pleating a filter medium with a large area. Avoiding pleating a filter medium with a large area should increase productivity, and as a result, reduce the cost. Moreover, it is easy to cope with a design change of the air filter because the air filter is fabricated by combining the plurality of filter units.

### BRIEF DESCRIPTION OF DRAWINGS

FIG. 1 is a perspective view of an air filter according to one embodiment of the present invention.

FIG. 2 is a perspective view of a filter unit used for the air filter shown in FIG. 1.

FIG. 3 is a cross-sectional view of the filter unit shown in FIG. 2, taken along the line

FIG. 4 is a cross-sectional view of the air filter shown in FIG. 1, taken along the line IV-IV

FIG. 5 is a cross-sectional view of a filter medium used for the filter unit.

FIG. 6A is a schematic view showing a structure for coupling the filter units to each other.

FIG. 6B is a schematic view similar to FIG. 6A.

FIG. 7 is a cross-sectional view showing a structure for fixing the filter unit to an outer frame.

FIG. 8 is a cross-sectional view of another example of the outer frame.

FIG. 9 is a diagram for illustrating a definition of an aperture ratio.

### BEST MODE FOR CARRYING OUT THE INVENTION

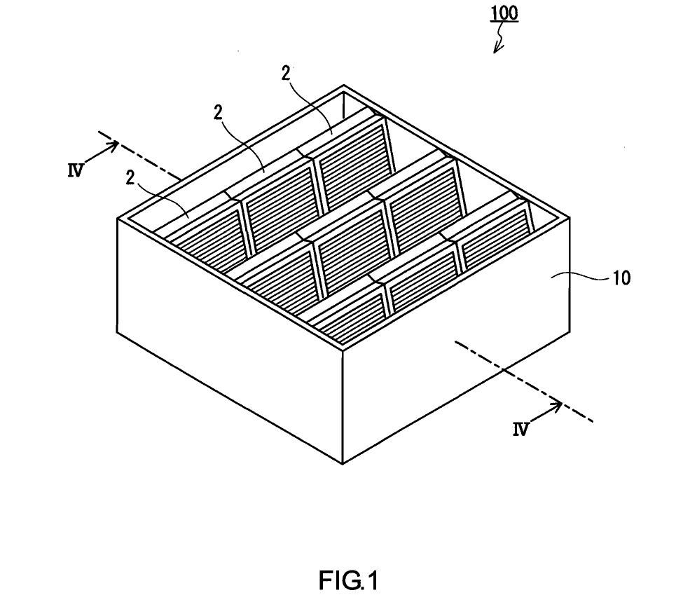

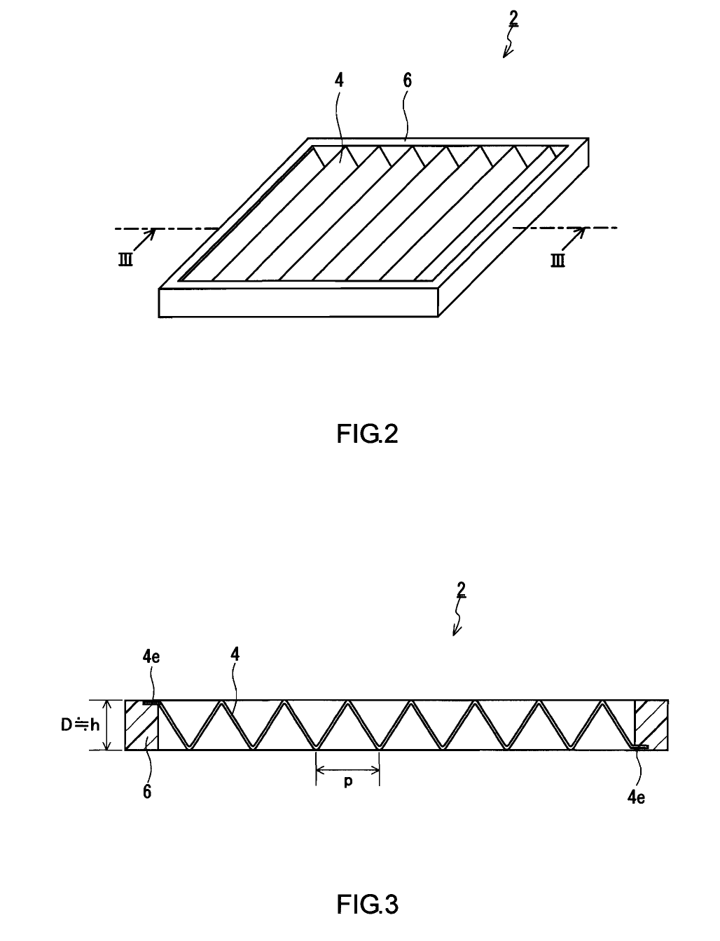

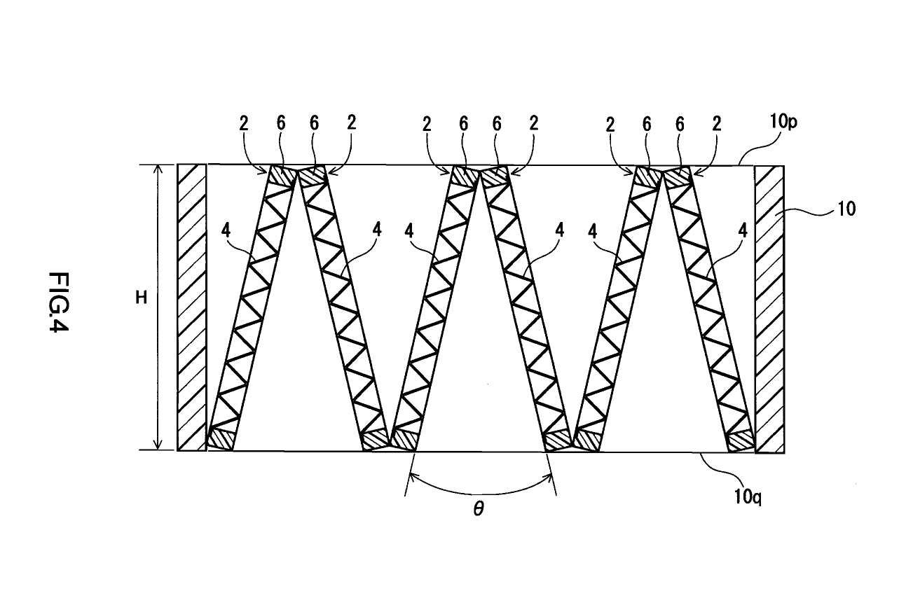

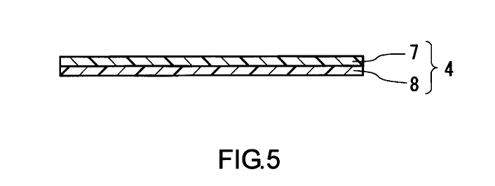

Hereinbelow, one embodiment of the present invention will be described with reference to the accompanying drawings. FIG. 1 is a perspective view of an air filter according to the present embodiment. FIG. 2 is a perspective view of a filter unit used for the air filter shown in FIG. 1. FIG. 3 is a cross-sectional view of the filter unit shown in FIG. 2, taken along the line III-III. FIG. 4 is a cross-sectional view of the air filter shown in FIG. 1, taken along the line IV-IV. FIG. 5 is a cross-sectional view of a filter medium used for the filter unit.

As shown in FIG. 1 and FIG. 4, an air filter 100 includes a plurality of filter units 2 coupled to each other so as to form a V-shape, and an outer frame 10 surrounding these filter units 2. As shown in FIG. 2, each of the filter units 2 includes a pleated filter medium 4 and a supporting frame 6 holding a peripheral portion of the filter medium 4.

The shape of the outer frame 10 of the air filter 100 and the shape of the supporting frame 6 of the filter unit 2 are not particularly limited. Usually, they are rectangular in a plan view. As can be understood from FIG. 2, the filter unit 2 has a plate-like shape as a whole.

As shown in FIG. 3, in the present embodiment, the supporting frame 6 of the filter unit 2 is made mainly of resin. The peripheral portion 4e of the filter medium 4 is embedded in the supporting frame 6 and integrated therewith. When the filter medium 4 is fixed to the supporting frame 6 in this manner, no gap is generated between the filter medium 4 and the supporting frame 6. This reduces the possibility of dust passing through the air filter 100 without being filtered by the filter medium 4. That is, the collecting efficiency is likely to increase. The phrase “to be made mainly of resin” means that the resin is the material contained in the largest amount in terms of mass % and other materials, such as glass fiber, also may be contained.

As shown in FIG. 1 and FIG. 4, in the present embodiment, the plurality of filter units 2 are coupled to each other at the respective supporting frames thereof so that adjacent two filter units 2 and 2 form a V-shape. The plurality of filter units 2 coupled to each other are fitted in the outer frame 10 so that all of the filter units 2 are inclined with respect to opening surfaces of the outer frame 10. Since all of the filter units 2 are inclined with respect to the opening surfaces of the outer frame 10, the collecting effect can be exerted using almost the entire surface of each of the filter media 4.

In the present embodiment, the number of the filter units 2 is 3 or more. These 3 or more of the filter units 2 are coupled to each other in a zigzag pattern. In other words, the plurality of filter units 2 are coupled to each other so that a ridge and a groove are formed alternately by the filter units 2 along a direction parallel to one side of the outer frame 10. This configuration makes it possible to achieve collecting efficiency comparable to those of the conventional V-bank filters, and provide an air filter with a large filter medium area.

As shown in FIG. 4, in the present embodiment, all of the plurality of filter units 2 are held between one opening surface 10p and another opening surface 10q of the outer frame 10. That is, the supporting frames 6 of the filter units 2 do not protrude from the outer frame 10. This is convenient for transporting and storing stacked air filters 100.

As shown in FIG. 1, in the present embodiment, two or more of the filter units 2 are disposed along a direction parallel to a ridgeline formed by the supporting frame 6 so that the plurality of filter units 2 are arranged in a matrix form within the outer frame 10. That is, the filter units 2 are arranged along both of a length direction and a width direction of the outer frame 10. The filter units are coupled so that adjacent two are flush with each other with respect to the direction (the length direction) parallel to the ridgeline. Coupling the filter units 2 in the length direction and the width direction in this way makes it easy to assemble the air filter 100 having target dimensions. Thus, the present embodiment can eliminate complexity in the manufacturing process of the conventional air filters, which requires pleating a filter medium with a large area many times.

The dimensions (length and width) of the outer frame 10 of the air filter 100 are not particularly limited. Generally, 610 mm×610 mm, which are standard dimensions for air filters, are used. Depth H (see FIG. 4) of the air filter 100 is not particularly limited, either, as long as a space for the filter units 2 coupled in a V-shape is ensured. The number of the V-shapes are not particularly limited, and may be determined so as to prevent the air filter 100 from having an excessively high pressure loss. Preferably, the number of the V-shapes is 3 to 8. In the present embodiment, three filter units 2 are disposed in the length direction parallel to the ridgeline of the V-shape, and six filter units 2 are disposed in the width direction (the direction in which the ridge and the groove are formed alternately) perpendicular to the ridgeline. That is, 18 filter units 2 are arranged in a length-width-wise matrix form within the outer frame 10.

As shown in FIG. 4, angle θ of the V-shape formed by two adjacent filter units 2 is in the range of 5° to 50°, for example. Coupling the filter units 2 at an angle in such a range makes it possible to ensure a sufficient surface area of the filter medium 4 with respect to the opening area of the outer frame 10.

The method for coupling the plurality of filter units 2 to each other is not particularly limited. For example, it is possible to couple the plurality of filter units 2 by welding the supporting frames 6 thereof, by using an adhesive, or by engaging the supporting frames 6 with each other. Or it is possible to couple the plurality of filter units 2 with a coupling tool. However, when the supporting frames 6 of the filter units 2 are made of resin, it is preferable to couple the plurality of filter units 2 by welding the supporting frames 6 because a gap is less likely to be generated therebetween.

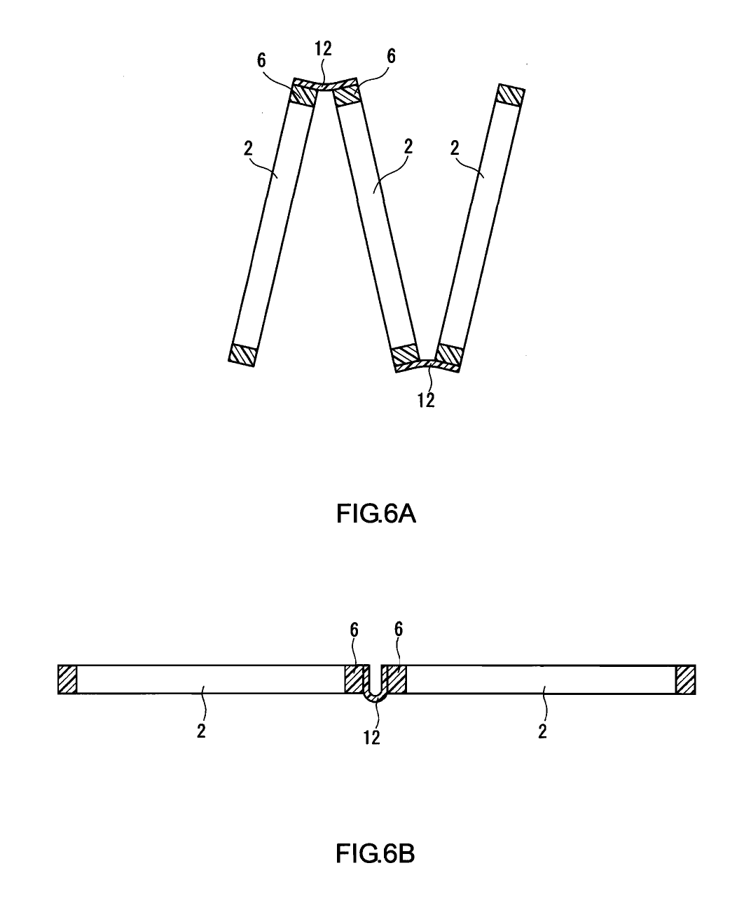

It is more preferable to provide a filter unit coupling member 12 coupling two filter units 2 and 2 by lying across the supporting frame 6 of one of the filter units 2 and the supporting frame 6 of the other filter unit 2 adjacent to the one filter unit 2, as shown in FIG. 6A. Use of the filter unit coupling member 12 makes it easier to couple the plurality of filter units 2 than bonding or welding the supporting frames 6 to each other directly. Furthermore, the filter unit coupling member 12 seals a gap between the supporting frames 6. Thereby, the collecting efficiency is enhanced.

The filter unit coupling member 12 has a strip-like shape. The filter unit coupling member 12 is provided on the ridge (or the groove) formed by the filter units 2. The filter unit coupling member 12 may be provided between the supporting frames 6 of the filter units 2 that are adjacent along the length direction parallel to the ridgeline of the V-shape.

It is desirable that the filter unit coupling member 12 be made of elastomer. Examples of the elastomer that can be used suitably include a polyurethane elastomer, a polyolefin elastomer, and a polyester elastomer. When the filter unit coupling member 12 is made of elastomer, the angle θ of the V-shape formed by two adjacent filter units 2 can vary due to a change in the deflection of the filter unit coupling member 12. In other words, the presence of the filter unit coupling member 12 makes it possible to adjust the angle θ of the V-shape. Moreover, when fixing the coupled filter units 2 to the outer frame 10, the angle θ changes slightly, and thereby a dimensional discrepancy between the filter units 2 and the outer frame 10 can be eliminated automatically. This makes it significantly easy to fix the filter units 2 to the outer frame 10.

The filter unit coupling member 12 can be formed by the following method. First, the above-mentioned elastomer is molded into a strip-like shape to obtain a strip-shaped molded product to serve as the filter unit coupling member 12. Then, as shown in FIG. 6A, the strip-shaped molded product is fixed to two supporting frames 6 with an adhesive or by welding (thermal welding or ultrasonic welding) so that the filter unit coupling member 12 lies across the supporting frames 6. By this method, the plurality of filter units 2 can be coupled to each other easily.

Alternatively, the filter unit coupling member 12 may be formed by a known resin molding method. For example, an injection molding method can be used suitably. For example, as shown in FIG. 6B, one filter unit 2 and another filter unit 2 are arranged so that sides of the supporting frames 6 of these filter units 2 face each other. Then, the resin is injection-molded so as to form the filter unit coupling member 12 of a U-shape lying across the supporting frames 6. By this method, the plurality of filter units 2 can be coupled to each other easily.

The material of the outer frame 10 is not particularly limited. The outer frame 10 may be made of metal or resin. From the viewpoint of reducing the weight of the air filter, the outer frame 10 preferably is made of resin.

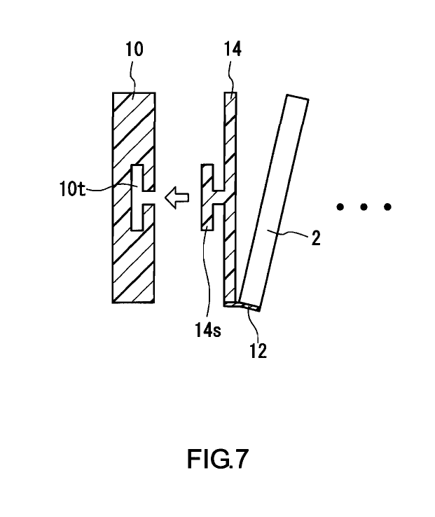

Although the coupled filter units 2 may be fixed directly to the outer frame 10, use of the fixing structure shown in FIG. 7 makes it easy to fix the filter units 2 to the outer frame 10. Specifically, it is possible to provide further an auxiliary frame 14 fixing the coupled filter units 2 to the outer frame 10. The auxiliary frame 14 is interposed between the filter unit 2 and the outer frame 10.

As shown in FIG. 7, the outer frame 10 has a depression 10t (or a projection), and the auxiliary frame 14 has a projection 14s (or a depression) with a shape conforming to that of the depression 10t of the outer frame 10. The projection 14s of the auxiliary frame 14 is fitted into the depression 10t of the outer frame 10. More specifically, the projection 14s and the depression 10t are engaged with each other by sliding the projection 14s having a T-shaped cross section into the depression 10t also having a T-shaped cross section. Thereby, the auxiliary frame 14 is fixed to the outer frame 10. On the other hand, the auxiliary frame 14 is coupled to the filter unit 2 with the filter unit coupling member 12. Thus, the filter unit 2 is fixed to the outer frame 10 via the auxiliary frame 14.

The structure shown in FIG. 7 lowers the possibility of a gap being generated between the filter unit 2 and the outer frame 10. This should enhance not only the workability but also the collecting efficiency. When the outer frame 10 is composed of a plurality of components and can be disassembled, use of the structure shown in FIG. 7 makes it easy to separate the filter unit 2 from the outer frame 10. This makes it significantly easy to perform tasks such as washing and replacing the filter unit 2.

It is not necessary to provide the fixing structure shown in FIG. 7 to all four inner circumferential surfaces of the outer frame 10. More specifically, a pair of the inner circumferential surfaces of the outer frame 10 are provided with the fixing structure shown in FIG. 7. Preferably, the other pair of the inner circumferential surfaces of the outer frame 10 are also provided with a design scheme for sealing the gap between the outer frame 10 and the filter unit 2. For example, a sealant, a caulking material, a gasket, or the like can be used for sealing the gap between the outer frame 10 and the filter unit 2. Or a groove may be formed in the inner circumferential surface of the outer frame 10 so that the filter unit 2 can be fitted thereinto.

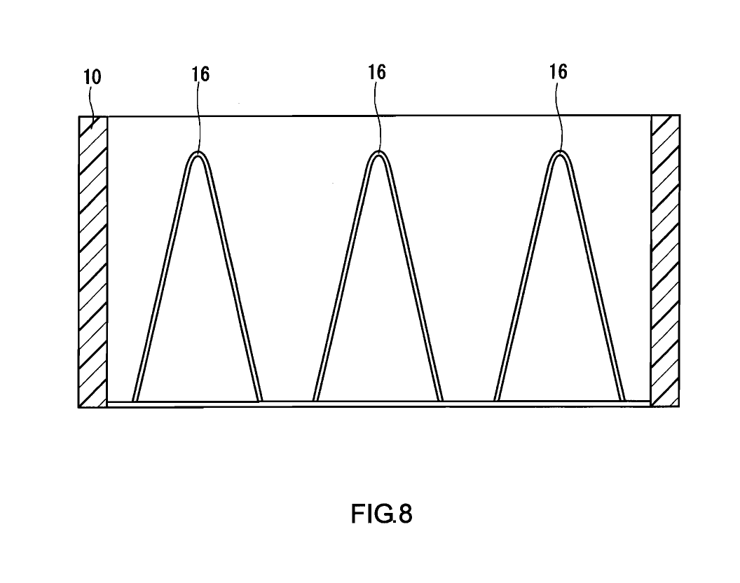

Moreover, as shown in FIG. 8, guides 16 (guide bars) for supporting the filter units 2 may be provided inside the outer frame 10. The guides 16 enhance further the ease of assembling the air filter, together with the effects exerted by the filter unit coupling member 12 described with reference to FIG. 6A and the auxiliary frame 14 described with reference to FIG. 7.

From the viewpoint of energy efficiency, the air filter 100 preferably has a pressure loss of 300 Pa or less when air permeates therethrough at a face velocity of 2.5 m/sec, and more preferably, a pressure loss of 250 Pa or less when air permeates therethrough at a face velocity of 3.5 m/sec. The filter medium 4 with an appropriate pressure loss is selected and the area thereof is decided based on the design of the air filter 100. In order to reduce the pressure loss, pitch P of the filter medium 4 (pleat pitch, see FIG. 3) can be set to 5 mm or less.

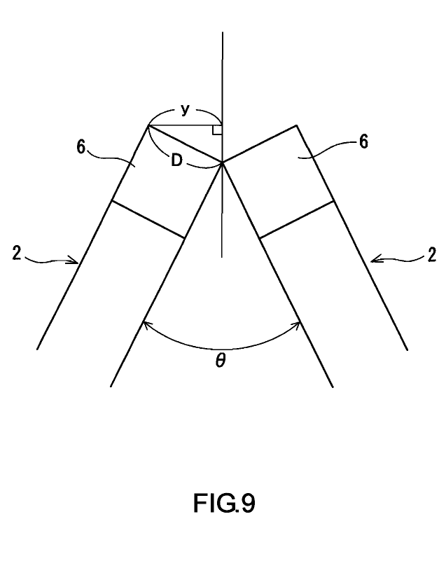

When the air filter 100 has an aperture ratio in the range of 30% to 65%, it is possible to keep the pressure loss low. Here, the “aperture ratio” is a value defined by formula (I) below. The formula (I) represents a ratio of the area of the sides of the supporting frames 6 to the opening area of the outer frame 10, when the air filter 100 is viewed in plane (see FIG. 9).

(Aperture ratio)=100×{W−(y×n×2)}/W (1)

W: Width of the outer frame 10 (mm)

y: D cos(θ/2) (mm)

D: Height of the supporting frame 6 (mm)

θ: Angle of V-shape

n: Number of V-shapes

The aperture ratio decreases as the area of the sides of the supporting frames 6 increases. Since the supporting frames 6 make no contribution to the air permeability, a smaller area of the sides is thought to be more preferable, that is, a higher aperture ratio is thought to be more preferable, from the viewpoint of reducing the pressure loss. However, an excessively high aperture ratio is not preferable because the total area of the filter medium 4 becomes insufficient, and as a result, a desired collecting efficiency is unlikely to be achieved and the pressure loss is likely to be increased against the expectation. Therefore, it is preferable to have the aperture ratio of the air filter 100 fall within the above-mentioned range by adjusting appropriately the dimensions of the outer frame 10, the dimensions of the supporting frame 6, and the number of the V-shapes.

The air filter 100 may be washed ultrasonically, for example, because it suffers no performance deterioration even when washed with water.

Preferably, the collecting efficiency of the filter unit 2 (the collecting efficiency of the filter medium 4) is 99% or more when particles with a diameter of 0.3 μm to 0.5 μm permeate through the filter medium 4 at a linear velocity of 5.3 cm/sec. More preferably, the collecting efficiency of the filter unit 2 is 99.97% or more when particles with a diameter of 0.3 μm to 0.4 μm permeate through the filter medium 4 at a linear velocity of 5.3 cm/sec. Further preferably, the collecting efficiency of the filter unit 2 is 99.9995% or more when particles with a diameter of 0.1 μm to 0.2 μm permeate through the filter medium 4 at a linear velocity of 5.3 cm/sec.

In the filter unit 2, the peripheral portion 4e of the filter medium 4 is integrated with the resin composing the supporting frame 6. Insert molding is preferable as the method for integrating the peripheral portion 4e of the filter medium 4 with the resin composing the supporting frame 6. The pleated filter medium 4 is set into a mold and injection molding is performed to obtain the filter unit 2. The resin composing the supporting frame 6 may be impregnated into the peripheral portion 4e of the filter medium 4, or may enter into a surface of the peripheral portion 4e of the filter medium 4 so as to form a structure of minute projections and depressions. In these cases, the filter medium 4 can be fixed firmly to the supporting frame 6.

The type of the resin composing the supporting frame 6 of the filter unit 2 is not particularly limited. Polyolefin, polyamide, polyurethane, polyester, polystyrene, polycarbonate, a composite of these, etc. can be used. Preferably, the shrinkage rate of the resin is 20/1000 or less, more preferably 10/1000, and further preferably 5/1000 or less. A filler can reduce the shrinkage rate of the resin when added thereinto. For example, addition of glass fibers or carbon fibers can increase the strength and heat conductivity of the resin along with the shrinkage rate. A pigment may be added to color the resin, and an antibacteria agent, etc. may be added to provide the resin with a antibacterial function. “The shrinkage rate of the resin” means a rate of dimensional change in the resin during the cooling process after the resin is molded (an amount of shrinkage of the resin during the cooling process/design dimensions of the mold).

As shown in FIG. 5, the filter medium 4 of the filter unit 2 preferably is composed of a filter medium main body 8 and an air-permeable fiber material 7 stacked on the filter medium main body 8. As the filter medium main body 8, one selected from the group consisting of a glass filter medium, an electret filter medium, and a filter medium including a porous PTFE membrane can be used. The glass filter medium is obtained by adding a binder to glass fibers and forming it into a sheet. The electret filter medium is obtained by turning a melt-blown nonwoven fabric into an electret. Among these, the porous PTFE membrane is recommended as the filter medium main body 8.

It is known that the glass filter medium self-generates dust of glass fibers when being pleated. When the glass filter medium is applied to a turbine, these glass fibers fall off from the filter, enter into the turbine, and adhere to a fan. When applied in a clean room, the glass filter medium tends to lower the degree of cleanliness in the room easily. Moreover, use of the glass filter medium makes the pressure loss relatively high. When the air filter uses the electret filter medium, the pressure loss is low but it is difficult to achieve HEPA-grade collecting efficiency. Furthermore, washing the air filter tends to lower the collecting efficiency easily. The filter medium including a porous PTFE membrane particularly is preferable as the filter medium 4 because it has overcome most of these disadvantages.

The thickness of the filter medium 4 is not particularly limited, but it needs to be of a level that allows the filter medium 4 to keep its pleated shape. Preferably, it is 0.05 mm to 1 mm. The filter medium 4 preferably has a pressure loss of 20 Pa to 300 Pa, and more preferably a pressure loss of 50 Pa to 200 Pa, when air permeates therethrough at a linear velocity of 5.3 cm/sec.

As shown in FIG. 3, the pleat pitch P of the filter medium 4 preferably is adjusted to a distance that allows the filter medium 4 to have a sufficient surface area per unit area of the air filter 100, for example, to a distance in the range of 1.5 mm to 6.0 mm. Pleat height h appropriately is in the range of 10 mm to 30 mm, for example. The above-mentioned beads may be formed on a surface of the filter medium 4. (The pleat height h of the filter medium 4) (Height D of the supporting frame 6) holds in the present embodiment. The height D of the supporting frame 6 may be different from the pleat height h of the filter medium 4.

The air-permeable fiber material 7 has a function as a reinforcing material. Furthermore, the air-permeable fiber material 7 itself has a dust collecting function and serves as a prefilter in some cases. In such a case, the filter medium main body 8 (for example, a porous PTFE membrane) is prevented from being clogged, an increase in the pressure loss due to the clogging can be suppressed, and the life of the air filter 100 is extended. According to a collecting theory, the dust collecting performance is enhanced when the air-permeable fiber material 7 is made of fibers with smaller diameters. Thus, it is more desirable that the air-permeable fiber material made of fibers with smaller diameters be disposed on an upstream side.

The material, structure, and form of the air-permeable fiber material 7 are not particularly limited. It is possible to use a material with a higher air permeability than that of the porous PTFE membrane, for example, felt, nonwoven fabric, woven fabric, mesh (mesh-like sheet), and other porous materials. The nonwoven fabric is preferable from the viewpoint of strength, collecting performance, flexibility, and workability. The air-permeable fiber material 7 is not particularly limited. The air-permeable fiber material 7 made of polyolefin (such as polyethylene (PE) and polypropylene (PP)), polyamide, polyester (such as polyethylene terephthalate (PET)), aromatic polyamide, or a composite of these can be used. It is preferable to use a nonwoven fabric made of fibers having a sheath-core structure in which a core part is formed of a material with a high melting point and a sheath is formed of a material with a low melting point.

Hereinafter, an example of the method for producing the porous PTFE membrane appropriate as the filter medium main body 8 will be described. First, a pasty admixture obtained by adding a liquid lubrication agent to PTFE fine powder is preformed. The liquid lubrication agent is not particularly limited as long as it can wet a surface of the PTFE fine powder and can be removed by extraction or heating. For example, hydrocarbon, such as liquid paraffin, naphtha, and white oil, can be used. An appropriate amount of the liquid lubrication agent to be added is approximately 5 to 50 parts by weight with respect to 100 parts by weight of the PTFE fine powder. The preforming is performed under a pressure of a level that does not squeeze out the liquid lubrication agent.

Subsequently, the preformed product is molded into a sheet-like shape by paste extrusion or roll pressing, and the resulting PTFE molded product is stretched at least in a uniaxial direction. Thus, the porous PTFE membrane 8 is obtained. It is desirable to stretch the PTFE molded product after removing the liquid lubrication agent. The stretching factor is not particularly limited, and may be set appropriately in accordance with the pressure loss and collecting efficiency. Taking into consideration the stretching unevenness, breakage during stretching, etc., the area stretching factor (obtained by multiplying the stretching factor used for the stretching in the uniaxial direction by the stretching factor used for the stretching in a direction perpendicular to the uniaxial direction) preferably is 50 to 900.

In the porous PTFE membrane 8, it is preferable that an average pore diameter is in the range of 0.01 μm to 5 μm, an average fiber diameter is in the range of 0.01 μm to 0.3 μm, and a pressure loss is in the range of 20 Pa to 2500 Pa when air permeates therethrough at a linear velocity of 5.3 cm/sec.

The porous PTFE membrane 8 with an average pore diameter of approximately 0.01 μm to 5 μm looks white. The air-permeable fiber material 7 of a standard grade also is white. However, they may be colored with a different color. The method for coloring them is not particularly limited, and methods of mixing a pigment, dyeing with a colorant, and printing can be mentioned. The color is not particularly limited and may be selected suitably in accordance with the application.

In the case where a pigment is mixed into the air-permeable fiber material 7, it is common to melt the source material plastic resin and knead it with the pigment. In the case where a pigment is mixed into the porous PTFE membrane 8, the pigment and a liquid lubrication agent are added to the PTFE fine powder so as to obtain a pasty admixture. Furthermore, a plurality of materials may be mixed in order to achieve another function, such as conductivity. In the case of dyeing with a colorant, the porous PTFE membrane 8 and the air-permeable fiber material 7 may be immersed in the colorant individually, or the filter medium 4, which is obtained by stacking these, may be immersed in the colorant. In the case of printing, gravure printing or the like commonly is performed.

The method for stacking the air-permeable fiber material 7 and the porous PTFE membrane 8 on each other is not particularly limited. They may be merely laid on each other, or may be stacked by a method such as adhesive lamination and heat lamination. In case of stacking by the heat lamination, a part of the air-permeable fiber material 7, which is, for example, a nonwoven fabric, is melted by heating so as to bond and stack the air-permeable fiber material 7 and the porous PTFE membrane 8. Or a fusing agent, such as a hot melt resin, may be interposed between the air-permeable fiber material 7 and the porous PTFE membrane 8 so as to bond and stack them.

The filter medium 4 is composed of the porous PTFE membrane 8 and the air-permeable fiber material 7 as described above, and other configurations thereof are not particularly limited. For example, the porous PTFE membrane 8 may be composed of a single layer, or two or more layers. When the porous PTFE membrane 8 has a multilayer structure, porous PTFE membranes having the same dimensions and properties as each other may be used, or porous PTFE membranes having different dimensions and properties from each other may be used.

### EXAMPLES

Next, examples and a comparative example of the present invention will be described.

### Example 1

The air filter according to Example 1 was produced by the following process. First, a porous PTFE membrane stretched by an area stretching factor of 450 was sandwiched between two sheets of PET/PE sheath-core nonwoven fabric (with a mass per unit area of 30 g/m²) so as to be stacked, and then made to go through a pair of rolls heated at 180° C. to be heat-laminated. Thus, a three-layer filter medium (with a thickness of 0.32 mm, a pressure loss of 170 Pa (at a linear velocity of 5.3 cm/sec), and a collecting efficiency of 99.99%) composed of the porous PTFE membrane and the air-permeable fiber material was obtained.

The obtained filter medium was pleated so that the pleat height h was 22 mm and the number of pleats was 93. The pleated filter medium was set into a mold, and a polycarbonate resin (containing 30% of glass fibers) was molded integrally (5 mm-thick) with the filter medium by an injection molding machine so that the supporting frame had a length of 195 mm, a width of 295 mm, and a height of 27 mm. Thus, the filter unit described with reference to FIG. 2 was obtained.

48 of the filter units were prepared and they were coupled to each other so that the number of V-shapes was 8. The coupled filter units were fixed to the outer frame made of resin. Thus, the air filter (V-bank filter with dimensions of 610 mm×610 mm×300 mm) described with reference to FIG. 1, etc. was obtained. The filter units were coupled to each other by welding the supporting frames thereof, and a gap between the filter unit and the outer frame was filled with a caulking material.

### Examples 2 to 6

42, 36, 30, 24, and 18 of the filter units used in the Example 1 were prepared, and they were coupled to each other so that the number of V-shapes was 7, 6, 5, 4, and 3, respectively. The coupled filter units were fixed to the same outer frame as in Example 1, with the angle θ (see FIG. 4) being changed. Thus, air filters similar to the Example 1 were obtained.

### Comparative Example 1

As Comparative Example 1, a commercially-available V-bank filter (610 mm×610 mm×292 mm) including a glass filter medium and an outer frame made of aluminum was prepared.

Subsequently, the air filters according to the Examples 1 to 6 and the Comparative Example 1 were measured for collecting efficiency and pressure loss. The methods for measuring the collecting efficiency and pressure loss were as described below.

<<Method for Measuring Collecting Efficiency>>

While air permeated through the air filter at a face velocity of 3.5 m/sec, particles of polydispersed dioctyl phthalate (hereinafter referred to as “DOP”) were supplied to an upstream side of the air filter at a concentration of approximately 10⁶ particles/liter. The particles had an average particle diameter (a particle diameter at an accumulated particle size distribution of 50%, measured by a laser scattering method) in the range of 0.3 μm to 0.4 μm. The DOP particles on the upstream side of the air filter and the DOP particles on a downstream side that had permeated through the air filter were measured for concentration by a particle counter, and the collecting efficiency was calculated by the following formula.

Collecting efficiency(%)=[1−(concentration on the downstream side/concentration on the upstream side)]×100

Unit of the concentration on the downstream side: Number of particles/liter

Unit of the concentration on the upstream side: Number of particles/liter

<<Method for Measuring Pressure Loss>>

The pressure loss when air permeates through the air filter at a face velocity of 3.5 m/sec was measured by a pressure gage (manometer).

Table 1 shows the measurement results of the collecting efficiency and pressure loss. Table 1 also shows the weights and aperture ratios of the air filters according to the Examples 1 to 6 and the Comparative Example 1.

TABLE 1

| | | | | | Aperture | Pressure | Collecting |
|---|---|---|---|---|---|---|---|
| | Dimensions (mm) | | | Weight | ratio | loss | efficiency |
| | Length | Width | Depth | (kg) | (%) | (Pa) | (%) |
| Example 1 | 610 | 610 | 300 | 16.2 | 25.8 | 324 | 99.99 |
| Example 2 | 610 | 610 | 300 | 15.2 | 35.2 | 249 | 99.97 |
| Example 3 | 610 | 610 | 300 | 14.2 | 44.5 | 220 | 99.98 |
| Example 4 | 610 | 610 | 300 | 13.1 | 53.9 | 245 | 99.99 |
| Example 5 | 610 | 610 | 300 | 12.1 | 63.4 | 249 | 99.99 |
| Example 6 | 610 | 610 | 300 | 11.0 | 73.0 | 295 | 99.85 |
| C. Example 1 | 610 | 610 | 292 | 25.0 | 33.0 | 349 | 99.99 |

Generally, the air filters according to the Examples 1 to 6 had smaller pressure losses than that of the air filter according to the Comparative Example 1. This is because the filter medium composed of the porous PTFE membrane and the air-permeable fiber material was used in the Examples 1 to 6, whereas the glass filter medium was used in the Comparative Example 1. The air filters according to the Examples achieved collecting efficiencies equivalent to that of the air filter according to the Comparative Example. The air filters according to the Examples 1 to 6 had smaller weights than that of the air filter according to the Comparative Example.

Despite the fact that the aperture ratio increased monotonically from the Example 1 to Example 6, the pressure loss did not decrease monotonically and it was lowest in the Example 3. The pressure losses of the air filters according to the Examples 2 to 5 were all in a preferable range of 250 Pa or less. In contrast, the pressure losses of the air filters according to the Examples 1 and 6 were slightly high, 324 Pa and 295 Pa, respectively. The maximum difference among the pressure losses of the Examples 2 to 5 was 29 Pa. In contrast, the difference between the pressure loss of the Example 1 and that of the Example 6 was as large as 75 Pa, and the difference between the pressure loss of the Example 5 and that of the Example 6 was as large as 46 Pa. The collecting efficiency of the air filter according to the Example 6 was 99.85%, which was slightly low.

As described earlier, it can be considered that these results are associated with the aperture ratio of the air filter. That is, it is preferable that the air filter according to the present invention has an aperture ratio that is neither too high nor too low. Specifically, it is possible to keep the pressure loss close to a minimum value by setting the aperture ratio in the range of 30% to 65% as in the air filters according to the Examples 2 to 5.

1. An air filter comprising:
a plurality of filter units; and
an outer frame surrounding the plurality of filter units, wherein:
the plurality of filter units each include a pleated filter medium and a supporting frame holding a peripheral portion of the filter medium;
the plurality of filter units are coupled to each other at the respective supporting frames thereof so that adjacent two of the filter units form a V-shape; and
the plurality of filter units are fitted in the outer frame so that all of the filter units are inclined with respect to opening surfaces of the outer frame.

2. The air filter according to claim 1, wherein:
the number of the filter units is 3 or more; and
the plurality of filter units are coupled to each other in a zigzag pattern.

3. The air filter according to claim 1, wherein all of the plurality of filter units are held between one of the opening surfaces and the other opening surface of the outer frame.

4. The air filter according to claim 1, wherein two or more of the filter units are disposed along a direction parallel to a ridgeline formed by the supporting frame so that the plurality of filter units are arranged in a matrix form within the outer frame.

5. The air filter according to claim 1, further comprising a filter unit coupling member coupling two of the filter units by lying across the supporting frame of one of the filter units and that of the other filter unit adjacent to the one filter unit,
wherein the filter unit coupling member seals a gap between the supporting frames.

6. The air filter according to claim 5, wherein the filter unit coupling member is made of elastomer.

7. The air filter according to claim 1, further comprising an auxiliary frame fixing the plurality of filter units to the outer frame, the auxiliary frame being interposed between the filter unit and the outer frame.

8. The air filter according to claim 1, wherein:
the filter medium includes a porous polytetrafluoroethylene membrane and an air-permeable fiber material stacked on the porous polytetrafluoroethylene membrane;
the supporting frame is made mainly of resin; and
the peripheral portion of the filter medium is embedded in the supporting frame and is integrated therewith.

9. The air filter according to claim 1, having a pressure loss of 250 Pa or less when air permeates therethrough at a face velocity of 3.5 msec.

10. The air filter according to claim 1, having an aperture ratio in the range of 30% to 65%.
